(19) United States
(12) Patent Application Publication
(10) Pub. No.: US 2025/0045789 A1
(43) Pub. Date: Feb. 6, 2025

(54) SYSTEMS AND METHODS FOR EVENT TRACKING

(71) Applicant: Kraft Sports and Entertainment LLC, Foxborough, MA (US)

(72) Inventors: Andrew NIELSEN, Elanora (AU); Frederick S. KIRSCH, Sandwich, MA (US); lkechukwu NNADI, Norwell, MA (US); Joseph DORANT, Dedham, MA (US); Michael LOYND, Medfield, MA (US)

(73) Assignee: Kraft Sports and Entertainment LLC, Foxborough, MA (US)

(21) Appl. No.: 18/791,009

(22) Filed: Jul. 31, 2024

Related U.S. Application Data
(60) Provisional application No. 63/529,979, filed on Jul. 31, 2023.

(51) Int. Cl. G06Q 30/0207

(52) U.S. Cl. CPC G06Q 30/0212

(57) ABSTRACT

An event tracking system is provided. The system includes one or more sensors. The sensors are configured to generate data regarding an event occurring on a physical event surface. The system is configured to generate a plurality of virtual event surface sections corresponding to a physical event surface, and to receive the event data from the sensors. The event data from the physical event surface includes a first position indicator and an activity indicator. The system is configured to correlate the event data to the virtual event surface sections using the first position indicator, and to determine a result value associated with the event data based on the activity indicator. The system is configured to update accumulated result values of users based on the result value and the correlated virtual event surface sections. The system is configured to perform an action based on the updated accumulated result values.

### CROSS-REFERENCE OF RELATED APPLICATION

This application claims the benefit under 35 U.S.C. § 119(e) of the filing date of provisional patent application Ser. No. 63/529,979 filed Jul. 31, 2023, the disclosure of which is incorporated herein by reference in its entirety.

### FIELD OF THE INVENTION

The subject matter disclosed herein relates to systems and method for tracking events.

### BACKGROUND OF THE INVENTION

For centuries, sporting and entertainment events have been extremely popular as spectator activities for various societies and civilizations. As technology has progressed, different technologies have been utilized to enhance spectator experience and engagement.

For example, in the twentieth century in American sports, newspapers, radio and then television were utilized to report on and/or broadcast sporting events hosted by football, baseball, basketball, and hockey leagues, as well as college sport organizations, and other organizations. These advancements in following, listening to and viewing sports enhanced the overall spectator experience, allowing spectators to read about, view and hear the games without being physically present.

In the late twentieth and into the now early twenty-first century, social media platforms have been utilized not only to allow fans to follow and track such events, but also to engage in communications and commentary surrounding such events. For example, fans can track the progress of sporting events on various mobile applications, comment on X and Instagram posts about their favorite teams or athletes, and participate in other forms of engagement utilizing known social media platforms. While actual videos of such events are widely utilized and available, interactive platforms and digital representations relating to events occurring on the physical surfaces of such events are not.

In order to advance their missions, companies and other organizations in the sports and entertainment space need to cultivate and grow the volume of their fans on an ongoing basis. Competing for fan engagement in the present age of social media, fantasy leagues, and other engagement platforms can be very challenging. Advancements in engagement and visualization technology is needed to advance these efforts and benefit the overall spectator experience.

Improvements to engagement and graphical user interface technologies are disclosed herein. These advancements include, but are not limited to, novel computer-related functionality directed to normalizing events occurring on a physical playing or performance surface with digital and segmented representations of such physical surfaces, displaying such digital surface segments to a user in a unique manner, and creating digital assets based on the digital surface segments and minting those digital assets.

### SUMMARY OF THE INVENTION

According to a first aspect, an event tracking system is provided. The system includes one or more sensors. The sensors are configured to generate data regarding an event occurring on a physical event surface. The system includes at least one memory. The memory comprises instructions executable by one or more processors. The one or more processors are configured to generate a plurality of virtual event surface sections corresponding to a physical event surface. The one or more processors are configured to receive the event data from the one or more sensors, wherein the event data from the physical event surface includes a first position indicator and an activity indicator. The one or more processors are configured to correlate the event data to at least one of the virtual event surface sections using the first position indicator. The one or more processors are configured to determine a result value associated with the event data based on the activity indicator. The one or more processors are configured to update accumulated result values of one or more users based on the result value and the correlated virtual event surface sections. The one or more processors are configured to perform an action based on the updated accumulated result values.

According to a second aspect, a method for managing virtual event surface sections associated with a physical event surface based on an event occurring on the physical event surface is provided. The method includes providing a plurality of virtual event surface sections corresponding to a physical event surface. The method includes receiving event data from one or more sources, the event data being associated with an event occurring on the physical event surface and including a first position indicator and an activity indicator. The method includes correlating the event data to at least one of the virtual event surface sections using the first position indicator. The method includes determining a result value associated with the event data based on the activity indicator. The method includes updating accumulated result values of one or more users based on the result value and the correlated virtual event surface sections. The method includes performing an action based on the updated accumulated result values.

### BRIEF DESCRIPTION OF THE DRAWINGS

The accompanying drawings, which are incorporated herein and form part of the disclosure, help illustrate various embodiments of the present invention and, together with the description, further serve to describe the invention to enable a person skilled in the pertinent art to make and use the embodiments disclosed herein.

In the drawings, like reference numbers indicate identical or functionally similar elements.

FIG. 1 illustrates a system for the creation and utilization of a digital asset according to an embodiment.

FIG. 2 illustrates a method for creating and utilizing a digital asset according to an embodiment.

FIG. 3 illustrates a user interface for utilizing a digital asset platform in a game including a leaderboard for tracking results (e.g. points) associated with playing or performance surface sections.

FIG. 4 illustrates a method for normalizing performance data to a virtual playing section according to an embodiment.

FIGS. 5-7 illustrate user interfaces according to an embodiment.

### DETAILED DESCRIPTION OF THE INVENTION

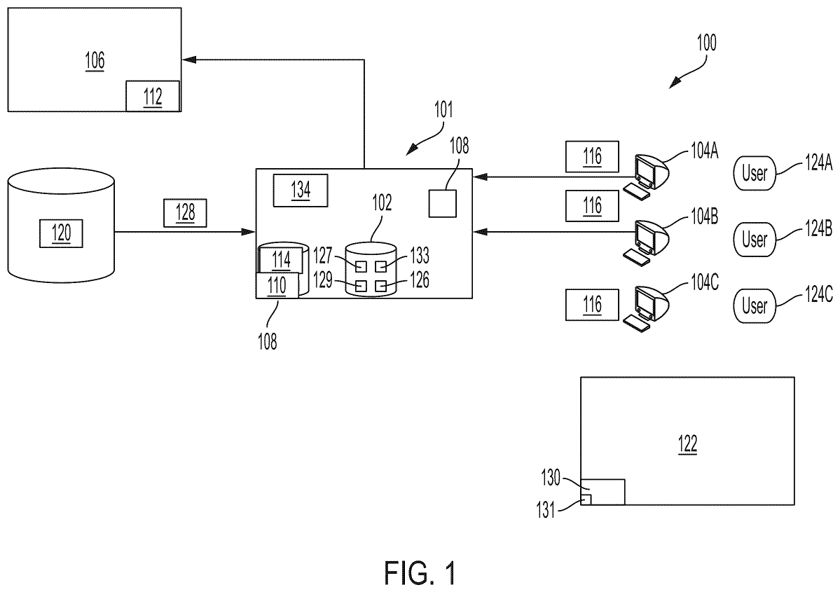

Referring now FIG. 1, an embodiment of a system 100 for the creation and utilization of a digital asset is shown.

A digital asset creation and utilization platform 101 is configured to communicate with a user 124A using a user device 104A and a distributed ledger 106. It will be understood that the digital asset creation and utilization platform 101 is configured to communicate with multiple users 124A, 124B, and 124C, through multiple user devices 104A, 104B, 104C. Utilization platform 101 comprises a network interface 134 (e.g., a physical interface or air interface) comprising a transmitter (Tx) and a receiver (Rx) for enabling utilization platform 101 to transmit data to and receive data from user devices 104A, 104B, 104C, distributed ledger 106, and a performance data server 120.

The digital asset creation and utilization platform 101 comprises storage memory components 108 that can include one or more computer readable storage mediums 110 designed to store executable instructions such as computer code, and one or more storage memory components designed to store other data utilized during the operation of the system 100.

In embodiments, the digital asset creation and utilization platform 101 further comprises a normalization algorithm 127 configured to communicate with one or more performance data servers 120. The digital asset creation and utilization platform 101 and normalization algorithm 127 are configured to parse performance data 128 received from the one or more performance data servers 120 and normalize that data with playing surface section data 131 as shown and described herein.

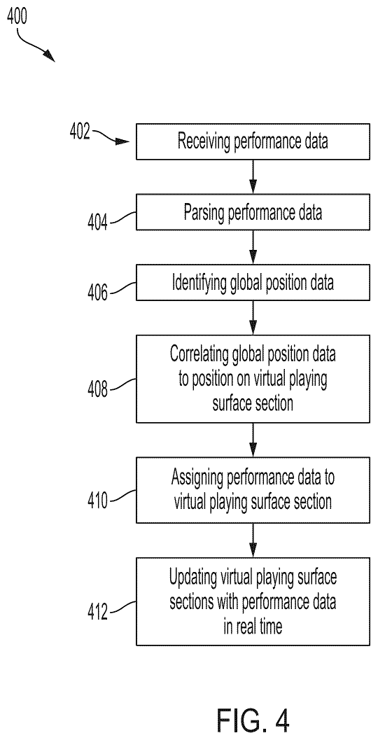

In embodiments, and as shown in FIG. 4 in accordance with method 400, in step 402 the normalization algorithm 127 receives performance data from a performance data server 120. As described below, the performance data may originate from multiple sources, including sensors, processing nodes, manual entry, etc.

In step 404, the normalization algorithm parses the performance data and in step 406 identifies or receives a geographic global position of the location where the activities of such performance data occurred on the physical playing surface. For example, the performance data may contain position information in it, associated with an event on the playing field. This position information may come from a global position system (GPS) or similar position tracking information, it may come from sensors (e.g., accelerometer), it may come from image analysis performed on video of the event (e.g., using machine learning or vision based algorithms), or it may be any combination of these or other ways of obtaining position information. The position information may be absolute or relative position, or a combination of both.

In step 408, the normalization algorithm correlates the global position data to a position on a virtual playing surface section (here, the virtual playing surface section can become a digital asset 112 and the subject of a digital asset file 114 as described and shown herein) and in step 410 assigns performance data to that virtual playing surface section. In step 412, the normalization algorithm operates continuously and updates corresponding virtual playing surface sections in real time. By real-time it is meant without significant delay, in the sense of being concurrent with the action taking place on the playing field. In certain embodiments, there may be a slight delay, e.g., on the order of several seconds, for one or more of the sources of performance data. In other embodiments, the performance data may be significantly delayed from the action taking place on the playing field (i.e., not real-time).

In embodiments, the performance data 128 includes, but is not limited to, data related to activities that interact with precise locations on the performance surface. Examples for the sport of football include, but are not limited to, Pass Completion (Point of Pass+Point of Reception), Yardage Gained on Play (Distance of Pass/Run+Yards After Catch), Yard Gaining Plays (Path of Run), Defensive Plays (Point of Interception, Tackle, Sack, Fumble), Scoring Play Interaction (Field Goals/Extra Points (i.e., Point of Kick)+Touchdowns (Point Touchdown is Scored)+Involvement on a Scoring Play (Run Path on Scoring Plays). Examples for the sport of Soccer include, but are not limited to, Goals (location where shot taken), Penalty kicks (location where kick taken), Head Shots (location where shot taken), and other activities. It will be understood that these are examples from a limited number of sporting events, but many other examples of relevant activities from these and other sports and performances (e.g., Motocross, concerts, baseball, lacrosse, hockey, lacrosse, etc.), can be utilized in the systems and methods described herein.

In embodiments, the digital asset creation and utilization platform 101 further comprises a cryptographic minting algorithm 129 configured to inscribe the digital asset file 114 to a blockchain, thereby creating a digital asset 112. The distributed ledger 106 is configured to contain data that correspond to one or more digital assets 112 representative of one or more digital asset files 114. In some embodiments, the digital asset 112 may be embodied as a cryptographic digital asset.

It will be understood that, in some embodiments, additions and modifications can be made to the information contained in the digital asset file 114 (including, but not limited to, based on data 128 received from the data server 120), and the platform 100 (including the cryptographic minting algorithm 129) is configured to update the digital asset 112, including in real time, with corresponding additions and modifications.

In embodiments, the cryptographic minting algorithm 129 is configured to access the digital asset file 114 and communicate with the distributed ledger 106 for the creation of digital assets 112. It will be understood that digital assets 112 can be modified and updated, including in real time, as new performance data 128 is received, normalized and attributed to the corresponding digital asset file 114 and playing surface section 130 as described herein. It is also understood that that the cryptographic minting algorithm 129 is also designed to interface with other applications in the distributed ledger and may use additional functionality implemented by already-existing applications of that distributed ledger.

Additionally, in embodiments, the digital asset creation and utilization platform 101 further comprises a result or point determining algorithm 133 that operates on the digital asset creation and utilization platform 101 for calculating result or point totals as described in FIG. 4.

In embodiments, the digital asset creation and utilization platform 101 further comprises a design file generator algorithm 126 capable of generating design files 114 containing 2D or 3D representations of playing surface section 130 derived from a physical playing surface 122. The design file generator algorithm 126 is configured to communicate with a network or server interface to cause a user device to display the 2D or 3D representations of playing surface section 130 derived from the design files 114. The user device may display the 2D or 3D representations of playing surface section 130 as part of a graphical user interface.

The user device 104A, 104B, and 104C may be utilized, for example, with the digital asset creation and utilization platform 101 to transact and utilize digital assets 112. Each user device 104A, 104B, and 104C is configured to store an executable program 116 that communicates with the digital asset creation and utilization platform 101 and allows the digital asset creation and utilization platform 101 to communicate with the user device 104A, 104B, and 104C.

In embodiments, the digital asset creation and utilization platform 101 is configured to communicate with the user devices 104A, 104B, and 104C and executable program 116. Each user device 104A, 104B, and 104C is configured to communicate with the digital asset creation and utilization platform 101 including to transact digital assets 112 as described herein. The digital asset creation and utilization platform 101 is configured to update the distributed ledger 106, including in real time, with new ownership information concerning the digital asset 112 following each transaction.

The computer readable storage medium 110 is configured to contain operable instructions for accessing and parsing the performance data 128 received from the data server 120. The computer readable storage medium 110 is further configured to contain operable instructions for facilitating transactions with the distributed ledger 106 for updating the attributes of one or more digital assets 112 located on the distributed ledger 106 based on the performance data 128 received.

It will be understood that in embodiments, the digital asset creation and utilization platform 101, and any and all of the algorithms operating therein, or in conjunction thereto, are configured to utilize the platform server 102 and any other physical or virtual server, servers, or server system operating on site, the cloud, or elsewhere.

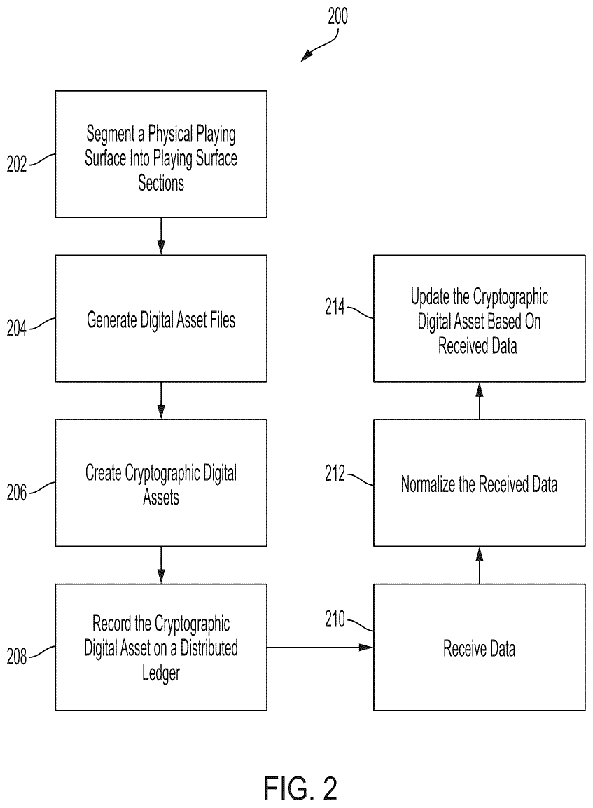

Referring now to FIG. 2, a method 200 for creating a digital asset 112 corresponding to a playing or performance surface in accordance with an aspect of the present invention is shown and described.

In step 202 of method 200 a physical playing surface 122 is defined and segmented into one or more playing surface sections 130. The playing surface 122 is understood to include any physical surface on which a sporting or entertainment event might occur. The playing surfaces 122 that might be utilized according to method 200 include, but are not limited to, a football field, a basketball court, a hockey rink, a baseball field, a tennis court, a putting green, a soccer field, a motorcycle type event, or any other surfaces utilized in sports or entertainment. This includes grass, artificial grass, dirt, clay, pavement, and so on, without limitation.

In embodiments, segmenting the playing surface 122 according to step 202 of method 200 includes defining the dimension 132 of the entire playing surface and creating sections 130 of the playing surface. In an example, the playing surface 130 is a rectangle (such as a football or soccer field) and a plurality of square or rectangular playing surface sections 130 are defined within the overall dimension of the playing surface 132 in a grid-like fashion. In an embodiment, according to a gridded representation of the playing surface 122, each playing surface section 130 is in a square shape and corresponding to 1 square yard of the playing surface 122. It will be understood that playing surface sections can be of any other shapes and sizes as segmented within the playing surface 122. The playing surface sections may be the same shape and/or size (as in the example just mentioned), or some or all of the playing surface sections may be different shapes and/or sizes from each other. For example, there may be playing surface sections corresponding to the width of the playing surface and each of a yard in length. On the other hand, there may be fewer playing surface sections (of larger area) in certain regions, such as those typically having less activity, and more playing surface sections (of smaller area) in other regions, such as those typically having more activity. It is also understood that playing surface sections may also overlap, where a given playing surface 122 can be contained within another surface. For example, playing surface 122 may represent the free throw lane in a game of basketball but there might be another version of playing surface 122 representing the entire area inside of the 3 point line.

In embodiments, the digital asset creation and utilization platform 101 is configured to assign section-specific data 131 to each playing surface section 130 including, but not limited to, data relating to playing surface section 130 dimensions, precise geographic locations of the playing surface section 130 (e.g., via global positioning), unique positioning identifiers of playing surface section 130 within the playing surface 122 (e.g., corresponding to each section's position on the grid), and other data relating each playing surface section 130 that is accessed by and otherwise utilized by the digital asset creation and utilization platform 101. In embodiments, the digital asset creation and utilization platform 101 is configured to store such data including through one or more of its servers 102. In addition to section-specific data, digital asset files 114 may also contain additional metadata, such as some or all game details or events that may have taken place in a section. For example, digital asset files 114 may also contain aggregated statistics representing the events that may have taken place in that section.

In step 204 of method 200 digital asset files 114 are generated using the digital file generator algorithm 126 such that digital asset files 114 correspond to a playing surface section 130 and accompanying section-specific data 131 are created. Metadata might also be associated with the digital asset file 114, indicating which particular playing surface section 130 the digital asset file 144 corresponds to. For example, the unique identifier assigned to the corresponding playing surface section 120 might be included in the metadata of the digital asset file 114.

In embodiments, digital asset files 114 are accessed by the normalization algorithm 127 (in normalizing digital asset files with performance data servers 120), cryptographic minting algorithm 129 (for inscribing the digital asset 112 to a blockchain), result or point determining algorithm 133 (for calculating results (e.g. points) as described herein), and design file generator algorithm 126 (for generating 2D or 3D design files depicting digital representations of the playing surface sections 120).

In step 206 of method 200 digital assets 112 are created by associating digital assets, including collectibles, non-fungible tokens (NFTs), or other forms that may arise in the future, with the digital asset files 114. In some embodiments multiple of such assets might be associated with a single digital asset file 114. In these embodiments, multiple digital assets 112 might each correspond the same playing surface section 130.

In step 208 of method 200 the digital asset 112 is recorded as a transaction on a distributed ledger 106. In embodiments, the transaction recorded on the distributed ledger 106 references the digital asset file 114. Thus, upon inscribing the digital asset 112 to the distributed ledger 106 the digital asset file 114 is now tied to a distributed ledger 106 address.

Each digital asset 112 created according to method 200 has a set of attributes defining its unique characteristics. For example, each digital asset 112 includes an attribute defining which particular playing surface section 130 the digital asset 112 corresponds to as well as any performance data 128 associated with it. In embodiments, cryptographic digital updates to performance data 128 attributable to each playing section (and thus digital asset 112), including in real time, are made.

In step 210 of method 200, performance data 128 relating to activities occurring during an event on the playing surface 122 is received from the data server 120. Because such performance data is related to activities occurring during an event on the playing surface 122, it may also be referred to as event data. In general, performance data 128 may originate from a variety of sources. For example, a sports league or other party may maintain certain statistics and other data related to game play during the course of a game, any of which may be incorporated into the performance data 128. As one example, players may wear gear which has sensors and other electronic equipment on it which may report on player positions and activity. Similarly, a football, or other piece of equipment, may also have sensors and other electronic equipment on it which may report on the equipment's positions and activity. Sensors in cameras may also provide visual data regarding activities occurring during an event on the playing surface 122. This data may be aggregated over all the players and equipment, and may be combined with other data indicating game play events (e.g., touchdowns, first downs, etc.). The performance data 128 may also be based, at least in part, on machine learning algorithms (e.g., computer vision related algorithms), and/or manual entry. Analysis (such as machine learning algorithms, including computer vision related algorithms) may be performed on the performance data 128, and the results of such analysis may be included as part of the performance data 128. For example, in some embodiments, such analysis may be used to determine one or more game play events associated with the performance data 128.

It is understood that the received performance data 128 generally comprises statistics related to an events occurring on the playing surface 122. For example, the received performance data 128 might include, but is not limited to, Passing Aerial Yardage (Point of Pass), Yardage after catch (Point of Reception), Yardage after interception (Point of Interception), Yard per Carry (Path of Run), Field Goals (Point of Kick), First Downs, Scoring Drives, Field Goals, or Touchdowns. For avoidance of doubt, and as indicated by these examples, events occurring “on” the playing surface 122 includes events in close physical proximity to the playing surface, such as an interception, even if the player making the interception and the ball being intercepted are not in direct physical contact with the field at the time of the interception.

It will be further understood that in one or more embodiments the data server 120 may provide performance data 128 related to other sports including, but not limited to, soccer, baseball, hockey, or basketball.

It should be further appreciated that the event occurring on the playing surface 122 might include, but is not limited to, a live sporting event or a prerecorded sporting event.

In step 212 of method 200, the received performance data 128 is normalized. Normalizing the received performance data 128 consists of correlating the received performance data 128 with a relevant playing surface section 130 and digital asset file 114. In embodiments, normalizing the performance data 128 includes correlating the geographic location of the received performance data 128 within the corresponding playing surface section 130. In some embodiments, the geographic location may be on the boundary of two or more playing surface sections (or within some threshold tolerance of the boundary). In that circumstance, a decision may be made to choose one of the playing surface sections over the others, or to correlate the event with multiple playing surface sections. In some embodiments, an event may be correlated with multiple playing surface sections near the geographic location for an event, such as any playing surface section within a certain threshold distance of the geographic location. It is understood that some events may occur above the playing surface (e.g., catching a ball in the air), and such events are correlated with a playing surface section below where the event occurred. For example, if a ball is caught above the 10-yard line at the sideline, or if a ball is caught by an in-fielder over third base, then that position on the playing surface field is correlated with the catching of the ball, even though the ball may have been caught above the surface. In general, locations where an event occurred may be projected onto a representation of the playing surface. Additionally, some embodiments may utilize a normalization mechanism 127 which applies a radius from the player's location to assess which playing surface section 130 a specific play corresponds to.

In step 214 of method 200 the digital asset 112 is updated based on the received and normalized performance data 128. It will be understood that these updates can be made in real time or may be inscribed to the digital asset 112 at a future point.

### User Engagement Application (Turf Game)

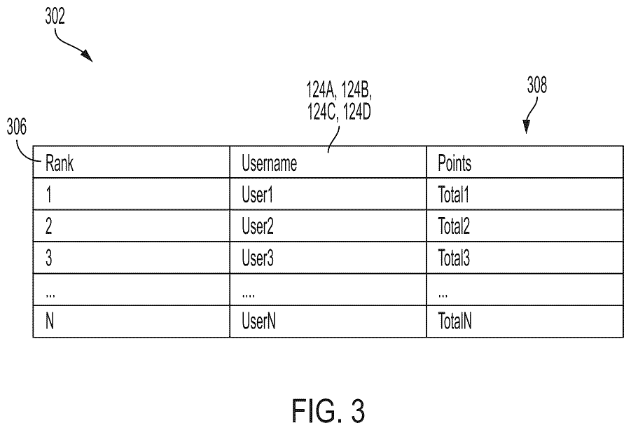

Turning now to FIG. 3, an exemplary user interface for a user engagement platform is shown. The user interface may be displayed on user devices 104A, 104B, and 104C as part of a graphical user interface. In an embodiment, the digital asset creation and utilization platform 101 is configured to support an application experience using method 200 wherein the application utilizes a leaderboard 302 for tracking results (e.g. points) associated with playing surface sections 130 owned by user 124A, 124B, and 124C s. As described herein, the digital asset creation and utilization platform 101 is operated by the owner (or related entity) of the subject playing surface 122. In some embodiments, playing surface 122 may be embodied as a performance surface.

In an embodiment, the leaderboard 302 tracks results (e.g. point) totals for User1 124A, User2 124B, User3 124C . . . . User N 124D. The leaderboard 402 further attributes a rank 306 to each user 124A, 124B, and 124C according to each user's 124A, 124B, and 124C point total 308. The point totals 308 correspond to attributes relating to at least one playing surface section 130 associated with a given user 124A, 124B, and 124C according to method 200.

The leaderboard 302 is updated using a point system to driven by a point determining algorithm 133. It will be understood that these updates can be made in real time. The point determining algorithm 133 determines point totals 308 according to the attributes of the digital assets 112 determined in method 200.

The point determining algorithm 133 aggregates the digital asset 112 attributes corresponding to the activities occurring on the corresponding playing surface section 130 as determined in method 200.

In embodiments, the point determining algorithm 133 assesses the activities attributed to the corresponding playing surface section 130 based on the relative importance of the activity. For example, significant activities like touchdowns, first downs, and turnovers might be worth more points that other recorded activities. Activities may also be awarded points based on one or more locations, such as where an event started and ended (e.g., the location of an interception as well as the location of where the play ended afterwards). Accordingly, in some embodiments, points may be awarded for multiple playing surface sections, and may be distributed among the playing surface sections (e.g., each gets the full amount of points for the event, the points are split between the sections according to a formula, or the different locations of an event are awarded points separately according to a point schedule).

For example, if an event on the playing field meets certain criteria, points may be awarded to the playing surface section where that event occurred. The points schedule may be known to users in advance. So if a pass is caught on one section (e.g., unique identifier GS2345) and advanced to another section (e.g., unique identifier GS2578), users who own those pieces of virtual surface sections may be awarded points as indicated on the schedule. In this case, further points may be added dependent on the result of the event (e.g., did the catch result in a 1st down or a touchdown? was it the last play of the game determining a win? was it a pass of over 25 yards? etc.).

In certain embodiments, points may be awarded to playing surface sections that are close to the geographic location of the event, but not exactly at that location. For example, a playing surface section close to (e.g., within one yard of) an event (e.g., an interception) may receive a fraction (e.g., 50%) of the points awarded to the playing surface section that corresponds with the geographic location of the event.

In embodiments, the digital asset creation and utilization platform 101 may also provide awards based on a user's 124A, 124B, or 124C standing on the 302 leaderboard. The digital asset creation and utilization platform 101 also provides a trophy room tied to the leaderboard 302. The digital asset creation and utilization platform 101 may also provide prizes and other benefits (virtual or real-life) based on a user's standing on the leaderboard. Other incentives for playing may also be given.

### Ownership

The digital asset creation and utilization platform 101 provides users 124A, 124B, and 124C the ability to own a specific playing surface 130 for the duration of a game. Depending on the events that may have taken place during a game, there may be units of playing surface 130 that without any corresponding playing surface section data 131 associated with it. In such circumstances, the playing surface may not be submitted to step 208 of method 200 where the digital asset associated with that location is minted.

Additionally, in an embodiment, the digital asset creation and utilization platform 101 provides users 124A, 124B, and 124C the capability to gift an owned digital asset 112 to another user 124A, 124B, and 124C. When a user 124A, 124B, and 124C chooses to gift a digital asset 112 to another user 124A, 124B, and 124C, this activity is recorded as a transaction on the distributed ledger 106 to reflect the updated ownership information associated with the digital asset 112. It will be understood that these updates can be made in real time.

A user's 124A, 124B, and 124C ownership of a digital asset 112 can vary in duration. In some embodiments, a user's 124A, 124B, and 124C ownership of the digital asset 112 is only applicable during a single event occurring on the playing surface 122. For example, in such embodiments a user's 124A, 124B, and 124C ownership of the digital asset 112 might be limited to a single game or match occurring on the playing surface 122.

In other embodiments, the user's 124A, 124B, and 124C ownership of the digital asset 112 might span a series of events occurring on the playing surface 122. For example, in such embodiments the user's ownership of the digital asset 112 might persist during an entire season or competition relating to a sporting event or a pre-set number of exhaustible games/matches.

The digital asset creation and utilization platform 101 further permits the owner 124A, 124B, and 124C of a digital asset 112 to customize a corresponding digital representation of a playing surface section 130.

The digital asset creation and utilization platform 101 may allow users 124A, 124B, and 124C to purchase more than one digital assets 112. For example, a user 124A, 124B, and 124C might choose to purchase three digital assets 112, each of which is associated with a different playing surface section 130. A user will have the option to buy multiple pieces as packs that will randomly award playing squares or specific single squares that others have put on sale in the marketplace.

Additionally, in an embodiment, common ownership of the digital asset 112 is permitted. For example, multiple users 124A, 124B, and 124C might possess co-ownership in one digital asset 112.

In another embodiment, multiple users might each individually and separately own digital assets 112 where each digital asset 112 represents the same playing surface section 130.

The digital asset creation and utilization platform 101 might limit the amount of users 124A, 124B, and 124C that can own digital assets 112 associated with a specific playing surface section 130. In some embodiments, the digital asset creation and utilization platform 101 might designate some playing surface sections as more “rare” than other playing surface sections 130. For the playing surface sections 130 considered “rare,” the digital asset creation and utilization platform 101 might only allow a predetermined amount of users 124A, 124B, and 124C to purchase digital assets 112 associated with these playing surface sections 130. In these embodiments, the predetermined amount of purchasable digital assets 112 corresponding to the “rare” playing surface sections 130 is less than the predetermined amount of purchasable digital assets 112 associated with the less “rare” playing surface sections 130. Users may also have a limit on what levels of squares they can play (e.g., only one “rare” playing square in play at a time).

It will be understood the digital asset creation and utilization platform 101 can freely determine the amount of available digital assets 112 corresponding to any given playing surface section 130.

Additionally, the digital asset creation and utilization platform 101 might restrict the number of digital assets 112 a user 124A, 124B, and 124C may own according to a predefined limit. It will be further understood that users will not be limited in the number of pieces they can own; however, they may be limited by how many playing squares they can put “in play” per game.

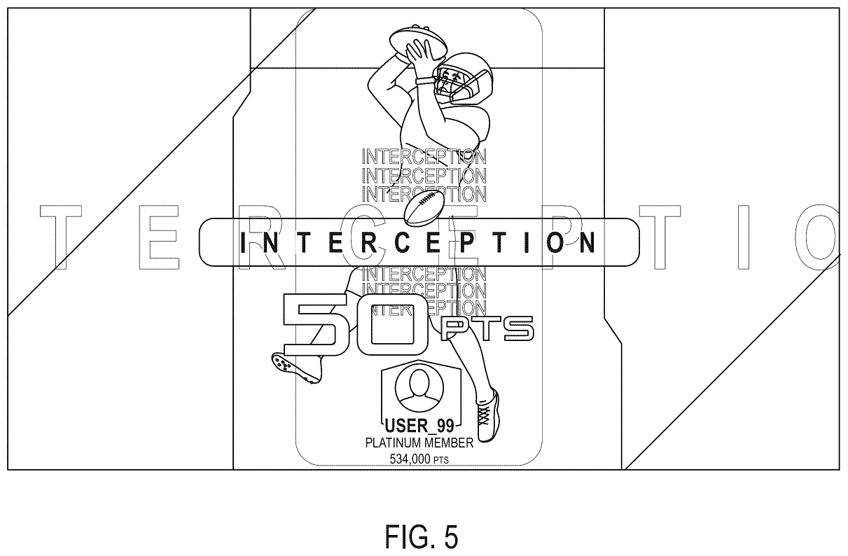

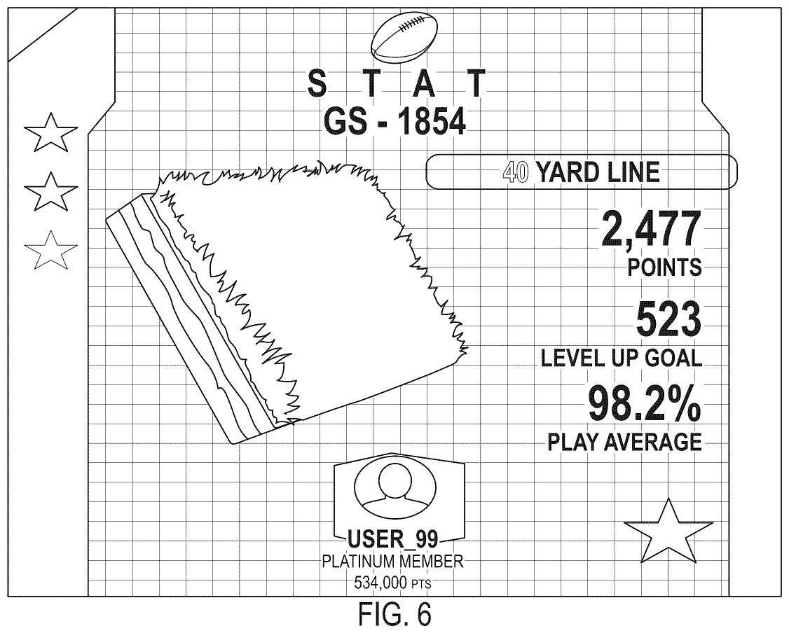

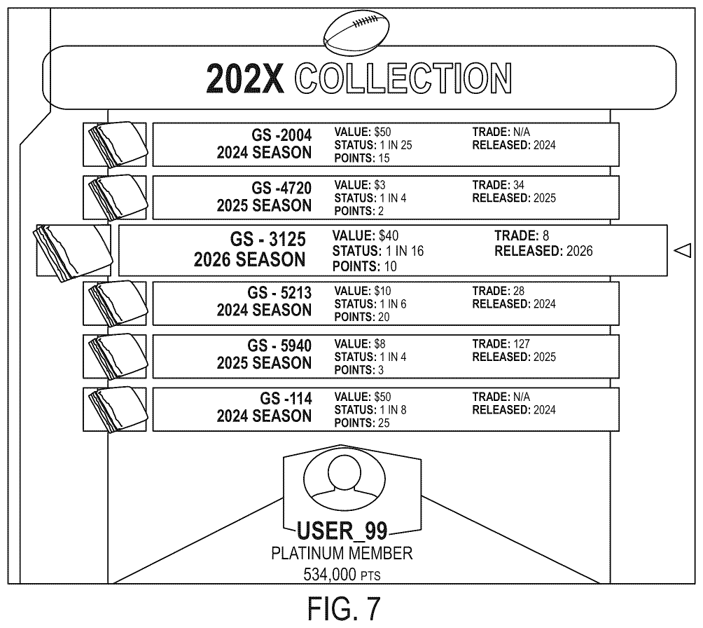

FIGS. 5-7 illustrate user interfaces according to an embodiment. For example, FIG. 5 illustrates a user interface showing an interception event, which resulted in 50 points being awarded to the user. In embodiments, the graphic of the event (here, an interception) may be a generic graphic, or it may come from an image or video of the actual game being played. FIG. 6 illustrates a user interface showing statistics related to a virtual playing surface section (here, shown with an identifier GS-1854). The virtual playing surface section is shown as being on the 40-yard line, and statistics relating to the total number of points for that section are shown, along with a play average rate and a level-up goal amount. FIG. 7 illustrates a user interface showing a listing of a user's virtual playing surface sections. As shown, a section identifier (e.g., GS-2004) is shown, along with a season the section is valid for (e.g., 2024 season), the value of the section (e.g., $50), the status of the section (e.g., 1 in 25, indicating a rarity of the section), whether and how often the section has been traded (e.g., N/A, indicating no trades), and when the section was released (e.g., 2024). The other sections shown have other exemplary values corresponding to those sections.

Various use cases for certain embodiments are provided below. These are not limiting, but provided to give additional context to how certain embodiments may be used. One or more use cases may be combined in certain embodiments, or certain aspects of different use cases may be combined. Such combinations may result in different user experiences.

### Use Case #1: Buy a Turf Pack

In embodiments, a user may buy a “turf pack,” e.g., from a “Pack Shop” tab provided on a user interface, where the user can see the option to buy different turf packs, sets of packs, or a single pack. Incentive to buy more may be provided; e.g., a discount for buying more packs, or buying in bulk up to a reasonable set limit. Here may also be a “My Turfs” tab provided on a user interface, where the user can view the amount of packs in their portfolio (e.g. shown in a grid-style layout). For example, the virtual turf pieces that a user owns may be displayed by highlighting or otherwise differentiating the owned pieces from the un-owned pieces in a layout corresponding to the playing surface. Alternatively, the user may be shown a list of the virtual turf pieces that are owned (e.g., by name or other identifier assigned to the virtual turf piece).

The use of the expression “turf” is derived from embodiments where the playing surface is grass or an artificial grass. However, the playing surface is not limited to these environments, and other types of playing surface (whether dirt, clay, pavement, etc.) are also within the scope of this and other embodiments described herein. By extension, “turf,” and “virtual turf pieces,” and similar terms, applies to any playing surface and virtual playing surface.

In embodiments, contents from packs can follow a color schema according to the rarity of the virtual turf pieces—e.g. common (white 1×), rare (blue 2×), legendary (red 5×), epic (gold 10×)—and a multiplier and potential secondary prize might come with a pack (e.g., an epic turf spot might be gold, with a 10× score multiplier and automatically come with a Pro Shop voucher or better). A virtual turf piece may be rare because only a limited number of that virtual turf piece are available to users (meaning only a relatively small number of users may own that virtual turf piece). On the other hand, a virtual turf piece may be common because there are more of that virtual turf piece available to users (meaning a larger number of users, potentially up to all users, may own that virtual turf piece).

In embodiments, a user may click a “Buy now/Play now” button in a Turf Play app to purchase the turf packs. A user may select a choice to buy single or multiple packs. The app may ask the user to confirm their purchase, after which it may complete a B2C (business-to-customer) e-commerce transaction. The app may then deliver the pack (or packs) to the user, which may contain mixed rarity virtual turf pieces.

A user may open a pack, which may then provide a visual and/or sound effect in the app. For example, opening the pack may cause a pop and may give a mini-explosion effect. There may additionally, or alternatively, also be a graphical effect, such as a football flying from the sky and crashing on a 3D-model field and the user's randomized spots spread out across the field indicating different rarity (lit up following a color schema), any multipliers, historic moments, potential prizes, and other attributes attached to the turf pieces.

As another example, a user may choose an option to open one pack at a time or numerous packs at a time—e.g., using a button click (highlight with press)—“would you like to open this pack?”—yes or click off screen, or—“would you like to open all your packs at once?” A user may have a multiplier to place or assign on a specific turf piece to earn more points during game play for that turf piece. Duplicate spots can count as a single spot multiplier if a user gets the same one twice and so on. One benefit of opening packs may be viewing historic moments that occurred on the virtual turf pieces in the pack. These moments may be collected in a “My Moments” tab offered on a user interface to be viewed on demand by a user.

### Use Case #2: Receive a Real-Time Light-Up

In embodiments, the app may feature a “Field” tab where there is a grid with all of the virtual turf pieces, and the turf pieces may be animated (or otherwise differentiated from other turf pieces) depending on what is happening on the field. For example, the turf piece where a score has been generated may be animated. Additionally, the turf pieces where scores have been generated for the current play, or for the current possession, or for the current quarter or half, or for some other duration or period, may be animated. By default, the user may be able to “zoom in” to areas of the field where they own turfs. Pieces may be animated differently depending on whether the user owns the turf piece or not. In some embodiments, only pieces that the user owns will be animated.

If app points are earned for any activity in the space, the platform may light up using a color schema with the team colors (e.g. for one team, silver may be for a big play, blue for a play that ends on a turf piece, red if a player stepped on their piece of turf) in a short animation. A user may see a replay of what happened—with animation, where the play started, what happened, points scored, their movement on the Leader Board. In some embodiments, an entire possession, or quarter, or half, or other period or duration of play, may be included in the replay.

The app may have a record of all turf pieces and be able to monitor for any on-field action (e.g., stats) as they occur within a broader radius from each turf piece (e.g. 10 yards). A user's turf piece may glow as plays get close to the turf piece, may be following a red to yellow to green color scheme. For example, even before a turf piece has any points from a play, the piece may be animated (or otherwise differentiated from other pieces) because the play is close to the turf piece (e.g., within 10 yards). A user's turf may light up (and/or visually jump out of the screen) as a play hits their turf piece, at which point the turf gets bright ‘money-like’ green or a shade of gold. Other color schemes or animations may also be possible to indicate these things. A user may choose to receive a notification when a play is ‘close’ or ‘hitting’ (which alerts the user when the app is not open or running, e.g., through a notification).

As another example, there could be other animations (e.g. when a player steps in the square multiple times, for a QB scrambling to avoid a sack). The user may be able to skip the highlights or not receive notifications unless it a big play or a large point score. The user may be able to select the type of plays, or score threshold, which would trigger a notification and/or animation of the virtual turf piece. A user may be able to nominate a team they are supporting, which may then result in a more dramatic animation for any of their turf pieces that scored there.

### Use Case #3: Check Leaderboard

In embodiments, a leaderboard may show a Turf Player avatar, handle, and their vital statistics. Vital statistics may include their points in the current game day, for the season, life time, any awards or prize count, relevant information about how long they have been a turf player and what competitions, huddles (“battles”) or sporting codes the user may be in. The leaderboard may be context-sensitive—e.g., based on what participation the user has and any current game day activity. The Leaderboard may have flag movement and trending features. The leaderboard may update dynamically, reflecting users' scores and rankings and the latest performance of all turf pieces.

A user may access the “Leaderboard” tab in the Turf Play app. The app may fetch the latest leaderboard data. The app may display the leaderboard to the user, showing the top-ranking players or scores. A user can scroll or navigate through the leaderboard to view other players or scores. The app may provide filters or sorting options to narrow down the results based on specific criteria (e.g. game day, season-to-date rankings). A user may be able to select a specific player or score to view more detailed information or their profile.

As another example, a user may want to search for specific other users or scores on the leaderboard. The app may then provide a search bar or filter option to enter the desired player name or score range.

### Use Case #4: Check Performance of Turf Piece

In embodiments, there may be a “My Turfs” tab in a user interface, where a user can view the amount of packs in their portfolio (e.g. a grid style layout). The “Field” tab displays a grid of turfs, animated to show live game actions (or replays). A user may zoom into specific parts of the field to focus on their own turf pieces or see it as a list of all of their owned turf pieces. Points may be awarded for game activities on owned turfs, with team-colored animations (e.g. silver for big plays, blue for completed plays, red for player in way that is consistent with the ‘Real-time light up’). The leaderboard may update dynamically, reflecting users' scores and rankings reflecting the latest performance of all their turf pieces.

A user may access the “My Turfs” tab in the Turf Play app. The app fetches the turfs with an option button to view bundled by pack. The app displays the list of turfs (or packs). A user selects a particular turf piece (or pack followed by a zoom in on specific areas to view their owned turfs). The app gives a visual indicator (e.g. flashing turf) of the latest and greatest earned points plus a full history for the turf piece. The screen may automatically update, displaying the user's new list based on the latest points earned.

As another example, a user may want to see a list that includes all their current as well as past (e.g., greyed out) turf pieces and which turf pieces earned them the most points (over all time or another specified period of their choice, such as the current game, pre-season play, post-season play, etc.). A user can watch replays of past events on any of their turfs including previously owned turfs (consistent with the ‘Real-time light up’).

Use Case #5: Play in a Huddle (Battle with Friends)

In embodiments, a user can choose to join a random team, or team up with friends, to compete within a group (referred to as a “Huddle”). In the Huddle, users can see their friends' avatars, supported teams, any “skins” they own, and the number of players in the Huddle. Established Huddles display statistics such as wins and losses over time by each user in the Huddle. As another example, Huddles may team-up and compete against other Huddle groups head-to-head. Bespoke Huddle leaderboards can exist on local, national, and international levels.

A user may access the “Huddles” tab in the Turf Play app. A user may create and name a new Huddle as free-for-all play, or create a team to compete against other teams worldwide. A user may invite friends to join by entering their username, email, Turf Play handle or other contact information. Huddle team owners may enter a marketplace to purchase “skins” or jerseys of their favorite teams, or create custom “skins” to use during battles. Users may have until kickoff to select which pieces of Turf they want to activate. For example, in a free-for-all, all turfs can be activated, while in team battles, each member can select a limited number, such as 3 turf pieces each. During the game, live leaderboards show current standings and projections, providing real-time updates on the competition.

As another example, a user may join an existing Huddle by entering an invite reference ID (or a click-through link from an email/social share). A game mode variation involves the Turfs being bundled into sections or quads. At least four users accept an invite from another user to “Huddle” (enabling users to compete 2 v. 2 for example). Whichever team gets the most points in each section may get all the points from that section and whichever team gets the most points wins.

### Use Case #6: Share on Socials

In embodiments, a ubiquitous “share” icon may appear on the home screen and all main submenus (tab landing screens). The icon may be fun to use and has a pliant response (e.g. a turf piece jumping out and then turning into the sharing caption screen). As another example, users may be able to do a shared post with their avatar, number of turf spots owned for that game, amount of points on the day, net money or other prizes gained. This may be a share on Instagram story, tweet (X), which is simple but gives all info needed from the day of game experience.

A user may click a “Share” or “Invite Friends” button in the Turf Play app. The app provides a list of available social media platforms. A user selects the desired social media platform. The app prompts the user to compose a message or caption for the shared post. The user writes a message or caption as desired. The user confirms the post details. The app posts the message, along with a link to download the app (or go to the website), on the chosen social media platform. The app displays a confirmation message to the user.

As another example, a user can share the app with specific friends or groups, via an additional option to select recipients before composing the message or caption. The user can repeat certain steps to share the app on multiple platforms.

### Use Case #7: Track Other Players

In embodiments, users of Turf Play may have social profiles with information like who their friends are, which team they are rooting for, and which games they are playing. Users may “follow” each other so that they can more easily see what their friends are doing and which games they are playing. There could be a “Feed” tab on the app where users can see all of the updates corresponding to the turfs of their friends and users they have added or that they are following. Celebrities may be featured (with permission) to appear on everyone's feed to increase engagement (e.g. you can see the turf pieces a celebrity or a favorite player owns and how they're doing).

A user may accesses the “Feed” tab in the Turf Play app. The app prompts the user to “Click on the add button to find your friends”. A search bar appears where the user can search their friends by typing their Turf Play handle, email or other contact details. The app returns a list of search results and the user clicks on the add button next to their name to include them in the Feed tab. On the user profile, there is a “Friends” or “Following” counter that, when clicked, enables users to see all profiles they are following. By clicking on a profile, they are taken to their page with all their information.

As another example, if the user already has friends or follows, the current game day points appear (or a countdown to the start of their next game). If there are no results from the search (i.e. their friend is not a Turf Play user) then the user can click on the “Invite Friends” button, which prompts a text message to the friend with an invitation to download the app. A user may click a “Stop following” button to remove a friend feed. A user may click a “My followers” button to see who added them, with a further option to remove the follower and/or be hidden from them/everybody.

### Use Case #8: Exchange Turf Pieces

In embodiments, a “Marketplace” section of the app may show each turf piece owned by a user. Options may be included to buy, sell, or swap a turf piece, which is in addition to any options appearing related to game play (e.g. checking performance of a turf piece, watching replays, statistics, historical moments, using multipliers). The marketplace may also show a 3D mockup of the venue the turf belongs to—allowing the user to select a specific turf piece to buy, sell, or swap, accompanied by key statistics of that turf piece. When trading, the user may be able to see their avatar and the avatar of the person they will be trading. When the trade is completed, animation of the turf piece may occur revolving in the center of the screen, and/or any other features similar to the opening of a pack that is described elsewhere.

For buying, a user may make a bid on anyone's turf and, if it's above the “reserve” or floor price that has been set, they receive a notification. Turfs that are more valuable (like end zone pieces) are color-coded to reflect that (e.g., they can be greener) and are zoomable and clickable. For selling, a user specifies their floor price for each turf being sold, with the app using heuristics to automatically suggest a price. When offering a turf for sale, a user is able to “promote” it on their feeds, where it is seen by all of their friends and followers. For swapping, a user may list preferences of turf they are looking for (e.g., midfield, end-zone, between the hash-marks, key statistics). Swapping may not have a fee attached to it. There may be no limit to the amount of trades a user can make. Alternatively, there may be a limit depending on the user type, and/or whether there is a limit may depend on the user type. For example, free-to-play (F2P) users may have a limit (e.g., five trades), while paying subscriber users may have a higher limit or even no limit.

### Use Case #9: Claim a Prize

In embodiments, after a game is over, prizes may be distributed to the highest-scoring players of any game day. These prizes can be perks, like attending a future press conference with the team, or more tangible items, like getting a rare or signed sneaker. The prizes may also relate to the app, such as providing access to more rare turf pieces, and so on. In some embodiments, a fixed number of points can be exchanged for a prize. Similarly, the more points a user has, the more valuable the prize/item/perk may be. Potential prizes can be shown that the user does not yet qualify for (e.g., greyed out) that serves as an incentive to keep playing.

The app may notify the user, via an in-app message, if they are a winner or have earned enough points for a prize. The user may click on a “Claim Prize” button (that only appears to users that have been successful) and they select from a list of what they can claim. Upon clicking the button, the user fills out a form for the delivery of the prize and accepts the terms and conditions of claiming the prize. The user's points are part of their profile on the app, and these points are seen to increase as each game day is played. The user may be invited to share with their friends on Turf Play or popular social media apps that they claimed a prize with a post that features a picture of the prize.

In another example, a user can decide to “save points” and not claim a prize if their balance is not big enough to claim the prize they want. If a user is short of making the required amount to claim a prize (e.g. the collectable sneakers), they can buy points with a credit card, or crypto.

### Use Case #10: Understand the Rules and Point System

In embodiments, the point system may be written and also have a short (e.g., one-minute) video that explains the rules and scoring system, and may provide examples or scenarios to illustrate the same. An example rule set for a football game follows:
1 pt=if player with the ball steps on turf.
5 pts=if play ends on turf
10 pts=if your team fumbles on your turf
10 pts=if your team recovers the ball
Interceptions=same as fumbles, maybe higher multiplier
10 pts=field goal if ball on turf (extra points don't count, if kick is good additional 10 pts, if no good/ball lands in play then multiply 10×)
50 pts=touchdowns (with multipliers based on location)
5 pts=sack (with multiplier based on location)
100 pts=safety
2 pts=tackle
25 pts=punt touchback on your turf
5 pts=fair catch
50 pts=“pinned deep” (plus multiplier)
Kickoffs

A user may access the “Rules” or “Help” section in the Turf Play app. The app displays a menu or list of available sports, game modes (e.g. Huddle) and countries. The app presents the rules, instructions and point system specific to the selected sport and game mode. The app may provide additional tutorials, videos, or interactive guides to explain the rules. A user can access and review additional resources or guides if available. A user can ask the app for clarification or details on specific rules or scoring. The app may allow the user to go back to the main menu or start playing.

### Use Case #11: Set Avatar and Handle

In embodiments, a user may customize their own profile on Turf Play so that it is more personalized to reflect their names, avatars and even teams they might support. All user settings are displayed on the user's profile, much like on social network platforms. Initially, in some embodiments, the user can set 3 parameters: Username, Avatar/Profile picture, and Description. The “Description” field is where the player can write about themselves and may be limited to ˜200 characters (e.g. “Based in Boston, Lifelong Fan).

When a user first creates an account they may be prompted by the app with the option to enter a username, avatar and description (this may be optional, e.g., because the user might be on a rush and want to get a pack prior to the start of game about to start). At any time the user may access the “App Settings” by clicking on a gear icon at the top right of the app home screen and main tab screens. In the settings, the app provides a User Profile section, where the user may choose to edit their avatars by uploading a pic from their phones, pick a different username, or add/edit their profile descriptions. The user may click “Save” and their profile is automatically updated. The app may display a confirmation message to the user. In another example, if the handle name is not available or invalid, the app prompts the user to choose a different name.

### Use Case #12: Choose Sport and Location and Game Day

In embodiments, when the user signs up for the first time they are able to share their location, as well as choose their favorite sports (and then teams). Once selected, the menu for a user's selections may appear with the marketplace, store to buy packs, and point system for the sport chosen.

The user may open Turf Play and the app presents an options screen. The user chooses their Sport, Country, Venue and Game Day to play (icons or drop-down boxes appear). The app has an info button to provide additional details about each match (e.g. time, participants, rules) for the user to review. A user can click a toggle button to show results in a scrollable list or as icons. A user may click their preferred option. The app opens the Venue (3D in branding) and the match on that Game Day.

In another example, a user can refine their search or selection based on preferred criteria (e.g. distance, rating, availability, calendar date picker). If there are no matches available, the app informs the user and provides alternative suggestions or options. The app allows the user to go back to the main menu or continue browsing for other matches.

### Use Case #13: Own a Turf (Mint a Collectible)

In embodiments, Digital Collectibles are a type of digital asset that enables “rarity” to be implemented digitally. Turf Collectibles are collectibles that can be optionally minted for a fee if a user wants to memorialize the game after it has ended. Turf Collectibles represent a physical turf piece in particular for memorable Turfs, like the yard where a particular player threw the last pass of his career, and would cost more to mint (i.e. generate). The Turf Collectible can represent either (a) a turf piece reflecting the activity of a single game or (b) a collectible representing the in-real-life turf (e.g. unique to when the IRL turf gets re-laid e.g. every 3 years) and/or (c) ownership shared across many users with more emphasis on a secondary marketplace for “turf shares.”

Turf Collectibles are fun to a wide demographic, even for users who are not tech-savvy, as they can then sell their “minting rights” to collectors. This makes the post-game even more fun for everyone, as turf owners can increase their winnings by selling their minting rights, or access other in-real-life (IRL) benefits such as a photo opportunity on the real-life equivalent turf.

After the game has ended, or the user has earned enough points, the app may notify the user they have earned the right to own turf and enables a button. If more than one turf is eligible then the user clicks the Turf piece to mint. The app shows the user 2 options to choose from (e.g. via ‘Own turf’ button).

Option 1: The user clicks “OWN (Mint Collectible).” The app shows a form with several fields to be filled out. The user pastes their crypto wallet address and pays a minting fee using their credit card or crypto, the minting fee varies on the basis of how “rare” the collectible is. Upon payment, the collectible is sent. The digital collectible lives on a distributed blockchain—it may be implemented via an NFT standard (e.g. ERC-712) to make it uniform and interoperable with infrastructure that already exists. Owning the collectible, much like owning a digital asset, means holding the keys (i.e. password) to the wallet that holds it. Once the Turf piece is minted, the user can decide what to do with it, such as trading in secondary markets, adding it to an online gallery, or using them to claim some of the IRL benefits listed above.

Option 2: The user clicks “DIVEST (Sell or Transfer Minting Rights).” The app uses data associated with that turf to get a base price for it. The user follows the recommendation from the app, or sets another price. Buyers have 24 hours to buy the minting rights or make an offer, otherwise the minting rights expire and are no longer available. The user pastes their crypto wallet address and pays a minting fee using their credit card or crypto, the minting fee varies on the basis of how “rare” the collectible is. Upon payment, the collectible is sent. The app takes the Turf out of circulation for the (a) specific game or (b) IRL equivalent and/or (c) applies shared ownership post-conditions.

It will be understood that not all of the steps in the methods described herein are required, or must be performed in the order as described herein.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. An event tracking system comprising:
one or more sensors, wherein the sensors are configured to generate data regarding an event occurring on a physical event surface;
at least one memory, wherein the memory comprises instructions executable by one or more processors, wherein the one or more processors are configured to:
generate a plurality of virtual event surface sections corresponding to a physical event surface;
receive the event data from the one or more sensors, wherein the event data from the physical event surface includes a first position indicator and an activity indicator;
correlate the event data to at least one of the virtual event surface sections using the first position indicator;
determine a result value associated with the event data based on the activity indicator;
update accumulated result values of one or more users based on the result value and the correlated virtual event surface sections; and
perform an action based on the updated accumulated result values.

2. The system of claim 1, wherein providing a plurality of virtual event surface sections corresponding to a physical event surface comprises segmenting a virtual representation of the physical event surface into the plurality of virtual event surface sections such that each of the virtual event surface sections corresponds to a unique area of the physical event surface.

3. The system of claim 1, wherein the event data is received in real-time.

4. The system of claim 1, wherein the event data further includes a second position indicator, and wherein the system is further configured to correlate the event data to at least another one of the virtual event surface sections using the second position indicator, determine another result value associated with the event data based on the activity indicator, and update the accumulated result values of the one or more users based on the another result value and the correlated virtual event surface sections.

5. The system of claim 1, wherein the action comprises providing an award to one or more of the one or more users.

6. The system of claim 1, wherein each of the virtual event surface sections corresponds to a non-fungible token (NFT).

7. The system of claim 1, wherein the one or more processors are further configured to: receive a notification that an event surface section was purchased by a user; link a unique digital asset code associated with the event surface section to the user; and transmit the unique digital asset code towards a distributed blockchain ledger.

8. The system of claim 1, wherein the one or more processors are further configured to:
display the virtual event surface sections, such that the virtual event surface sections corresponding to the event occurring on the physical event surface are indicated differently from other virtual event surface sections; and
provide information about the event occurring on the physical event surface through the corresponding virtual event surface sections.

9. A method for managing virtual event surface sections associated with a physical event surface based on an event occurring on the physical event surface, the method comprising:
providing a plurality of virtual event surface sections corresponding to a physical event surface;
receiving event data from one or more sources, the event data being associated with an event occurring on the physical event surface and including a first position indicator and an activity indicator;
correlating the event data to at least one of the virtual event surface sections using the first position indicator;
determining a result value associated with the event data based on the activity indicator;
updating accumulated result values of one or more users based on the result value and the correlated virtual event surface sections; and
performing an action based on the updated accumulated result values.

10. The method of claim 9, wherein providing a plurality of virtual event surface sections corresponding to a physical event surface comprises segmenting a virtual representation of the physical event surface into the plurality of virtual event surface sections such that each of the virtual event surface sections corresponds to a unique area of the physical event surface.

11. The method of claim 9, wherein the event data is received in real-time.

12. The method of claim 9, wherein the event data further includes a second position indicator, and wherein the method further comprises correlating the event data to at least another one of the virtual event surface sections using the second position indicator, determining another result value associated with the event data based on the activity indicator, and updating the accumulated result values of the one or more users based on the another point value and the correlated virtual event surface sections.

13. The method of claim 9, wherein the action comprises providing an award to one or more of the one or more users.

14. The method of claim 9, wherein each of the virtual event surface sections corresponds to a non-fungible token (NFT).

15. The method of claim 9, further comprising:
receiving a notification that a event surface section was purchased by a user;
linking a unique digital asset code associated with the event surface section to the user; and
transmitting the unique digital asset code towards a distributed blockchain ledger.

16. The method of claim 9, further comprising:
displaying the virtual event surface sections, such that the virtual event surface sections corresponding to the event occurring on the physical event surface are indicated differently from other virtual event surface sections; and
providing information about the event occurring on the physical event surface through the corresponding virtual event surface sections.
